(19) United States
(12) Patent Application Publication
(10) Pub. No.: US 2017/0032338 A1
(43) Pub. Date: Feb. 2, 2017

(54) PAYMENT METHODS AND SYSTEMS

(71) Applicant: NCR Corporation, Duluth, GA (US)

(72) Inventor: Suzan Szollar, Menlo Park, CA (US)

(21) Appl. No.: 14/812,444

(22) Filed: Jul. 29, 2015

(51) Int. Cl. G06Q 20/10; G06Q 30/02

(52) U.S. Cl. CPC G06Q 20/102; G06Q 30/0226

(57) ABSTRACT

Systems and methods for making a payment may include receiving, at a computing device comprising a processor, payment information regarding the payment. Once the payment information is received, the computing device may select a form of payment from a plurality of forms of payment based upon the payment information by comparison of a benefit received using each of the forms of payment. After selecting the form of payment, the computing device may make the payment via the form of payment.

### SUMMARY

Systems and methods for making a payment may include receiving, at a computing device comprising a processor, payment information regarding the payment. Once the payment information is received, the computing device may select a form of payment from a plurality of forms of payment based upon the payment information by comparison of a benefit received using each of the forms of payment. After selecting the form of payment, the computing device may make the payment via the form of payment.

### BRIEF DESCRIPTION OF THE FIGURES

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 shows an operating environment for making a payment consistent with the disclosure;

FIG. 2 shows an example schematic of a computing device;

FIG. 3 shows an example method for making a payment;

FIG. 4 shows an example subroutine for selecting a form of payment;

FIG. 5 shows an example user interface for making a payment; and

FIG. 6 shows an example user interface for making a payment.

Corresponding reference characters indicate corresponding parts throughout the several views. The exemplifications set out herein illustrate exemplary embodiments of the invention, and such exemplifications are not to be construed as limiting the scope of the invention any manner.

### DETAILED DESCRIPTION

The following detailed description refers to the accompanying drawings. Wherever possible, the same reference numbers are used in the drawings and the following description to refer to the same or similar elements. While embodiments and examples are described, modifications, adaptations, and other implementations are possible. For example, substitutions, additions, or modifications may be made to the elements and stages illustrated in the drawings, and the systems and methods described herein may be modified by substituting, reordering, or adding stages to the disclosed methods or elements to the discloses systems. Accordingly, the following detailed description does not limit the disclosure. Instead, the proper scope of any invention disclosed herein is defined by the appended claims.

When shopping consumers may have a variety of payment methods available to them. The available payment methods may include, but are not limited to, various credit cards, either specific to store (e.g., a Macy's® card, Target® card, etc.) or general credit cards (e.g., American Express®, Visa®, etc.); payment apps, such as Apple® Pay, Google® Wallet, PayPal®, etc.); cash; and gift cards. The location where the purchase is taking place may also offer rewards or other discounts for shopping at the location or for paying via a certain payment method or payment methods. For example, while shopping at Target®, a customer may be given a 5% discount for paying with a Target® card.

In addition to rewards and discounts, certain retailers may only allow certain forms of payment. For example, some retailers may not accept all forms of payment, such as American Express® and other retailers may only accept American Express®, cash, and debit cards as forms of payment.

One problem consumers face with having a variety of payment options is that consumers may be overwhelmed and not know which payment option is the best for them. As a result, consumer may revert to a default form of payment. For instance, a consumer may have multiple credit cards, cash, etc. in his or her possession, but when a payment needs to be made the consumer does not know the best payment option for him or her. As a result, the consumer may utilize a default payment method (e.g., a debit card).

Because the user is not able to determine the best form of payment to utilize, the consumer may be forgoing many potential rewards. For example, a user may not realize that if he or she uses a certain credit card, he or she may be awarded points or miles that could earn him or her a free plane ticket. In addition, because the consumer may carry a balance on his or her credit cards, he or she may not realize that by using one card over another he or she will save money due to a lower interest rate associated with one card versus the other.

As disclosed herein, upon receiving information about a payment, a computing device may select a payment based on the information. The computing device may incorporate various data that can be used to determine and select a form of payment from forms of payment available to a user. The form of payment may be selected based on a comparison of benefits received for using each of the forms of payment. Once a form of payment has been selected, the payment may be made.

For example, to select a payment the computing device may cycle through each form of payment available to a user and may calculate a cost and benefit associated with each form of payment. For instance, one form of payment may be a credit card that awards a percentage of the purchase as cash back. Another form of payment may award miles or points that can be used for airline travel. A third form of payment may have not rewards for the location where the payment is taking place. Of the forms of payment available, the form of payment selected may be the form of payment that has the highest reward to the user, the lowest cost to the user, or results in a beneficial financial impact to the user.

The financial impact to the user does not have to be an immediate financial impact. As discussed herein, the financial impact to the user may be cumulative. In other words, the overall impact on the user's financial situation may be considered when selecting the form of payment. Furthermore, a preference or preferences of a user may also be factored into selecting the form of payment to be used to make the payment.

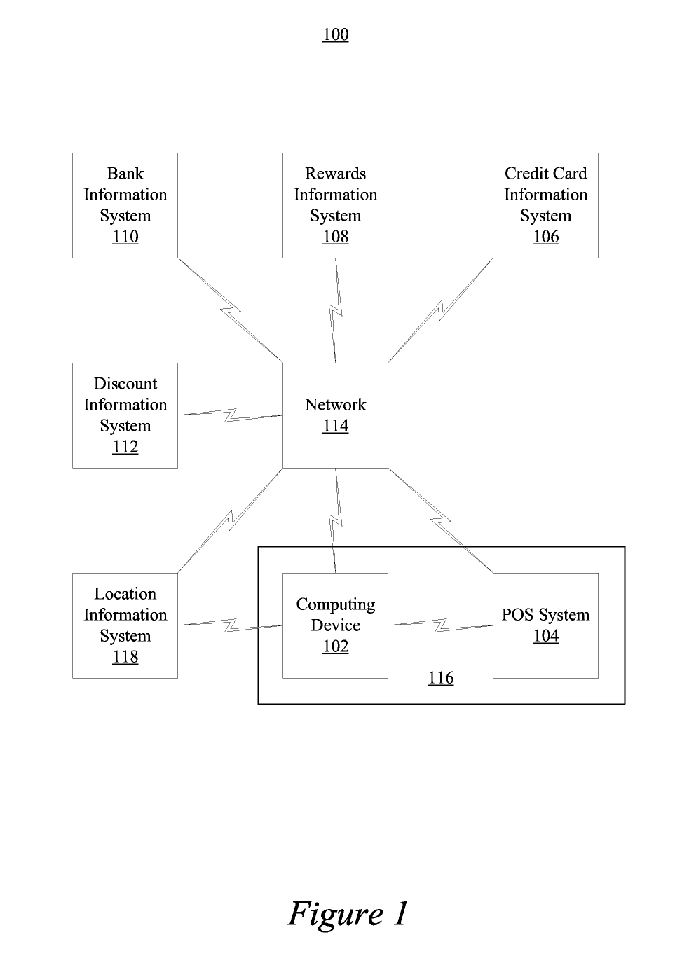

FIG. 1 shows an operating environment 100 for selecting a form of payment from available forms of payment and making a payment using the form of payment selected. Operating environment 100 may include a computing device 102, a point of sale (POS) system 104, a credit card information system 106, a rewards information system 108, a bank information system 110, and a discount information system 112. Computing device 102 may be connected to POS system 104, credit card information system 106, rewards information system 108, bank information system 110, and discount information system 112 via a network 114. Non-limiting examples of network 114 include the Internet, a local area network, a wide area network, etc. In addition, computing device 102 may connect with POS system 104 via short-range communication protocols. Non-limiting examples of short-range communication protocols include Bluetooth®, near-field communication, contactless EMV chip, etc.

Computing device 102 and POS system 104 may be located at a location 116. Location 116 may be, but is not limited to, a retail establishment, a service establishment, etc. For example, computing device 102 may be a smartphone operated by a user and POS system 104 may be a cash register operated by a merchant. In this instance, computing device 102 and POS system 104 may communicate via short-range communication protocols as described herein. In addition, computing device 102 and POS system 104 may also communicate using network 114. Computing device 102 and POS system 104 may also communicate using a combination of network 114 and short-range communication protocols.

In addition, computing device 102 and POS system 104 may be located at different locations. For example, computing device 102 may be a smartphone or a personal computer. POS system 104 may be a webserver hosting an ecommerce system. In this instance, computing device 102 and POS system 104 may communicate via network 114.

During use computing device 102 may enter location 116. As will be described herein, upon entering location 116, computing device 102 may begin calculating potential rewards, discounts, or other incentives that may influence the form of payment used for a purchase. Computing device 102 may recognize location 116 due to a signal received from POS 104 or other transmissions broadcast by equipment located at location 116. For example, computing device 102 may receive notification of location 116 by receiving Bluetooth® pings from transmitters located at location 116. Computing device 102 may also receiving information from hotspots that have known associations with location 116. Other type of beacons can be user to provide details regarding location.

In addition, GPS receivers within computing device 102 may also allow computing device 102 to determine that computing device 102 is located at location 116. Furthermore, geofences, created by a user or by proprietors at location 116, may be used to signify that computing device 102 is located at location 116. Furthermore, location 116 can be subdivided into smaller regions. For example, location 116 may be a tradeshow, flea market, or other event where vendors set up booths to market merchandise or services. In such instances, geofences may be created for each booth or space occupied by vendors. Once the user crosses a geofence established by a particular vendor, computing device 102 may receiving an indication that computing device 102 is within the geofence.

Upon receiving the location information, computing device 102 may determine acceptable forms of payment from a plurality of forms of payment. For example, upon entering a store and receiving location information, computing device 102 may cycle through a plurality of forms of payment that a user has entered into computing device 102 to determine which of the plurality of forms of payment the store accepts. For instance, the store may only accept American Express® cards and the user may have entered an American Express® card and a MasterCard®. As such, upon entering the store, computing device 102 may cycle, in the background, through the two forms of payment the user has entered and determine that only the American Express® card is an acceptable form of payment.

Computing device 102 may also receive credit card information from credit card information system 106. While only a single credit card information system is shown in FIG. 1, computing device 102 may receive information from multiple credit card information systems. Credit card information system 106 may distribute, upon request or via push mechanisms, information regarding one or more credit cards to computing device 102 via network 114. For example, credit card information system 106 may provide information such as, but not limited to, credit card balances, standard interests rates, interest paid on card balances, promotional interest rates, special interest rates for certain retailers or for purchases certain goods or services, a percent cash back for purchases, etc. In addition, credit information may include information an issuer of credit may use to extend credit to a user. For instance, credit information may include, but is not limited to, credit history, available credit, credit scores, payment history, etc.

Computing device 102 may use the credit card information to determine a cost or financial impact on a user for using a credit card. For example, if a user does not normally pay his or her credit card balances in full every month and accrues interest charges, computing device 102 may use the interest rates imposed by the issuers of each credit card the user possesses to determine a cost for using each credit card. The costs include the costs of the goods or services being purchased as well as the interest charges for financing the purchase via a credit card.

For example, if the cost of an item is $100.00 and the interest charges during the time it takes the user to pay off the credit card balance associated with the $100.00 purchase is $50.00 for card A, $40.00 for card B, and $42.00 for card C, then principle and interest costs for making the purchase with card A is $150.00, $140.00 for card B, and $142.00 for card C.

In addition, computing device may factor in whether or not a user generally carries a balance or pays his or her balance in full each month. For example, probability calculation can be used based on payment history. For instance, whenever a user's balance is below a certain amount the user may be more likely to pay his or her balance in full. When the he user's balance is above a certain amount the user may be more likely to carry a balance.

For example, when the user's balance is below $250 the probability that the user will pay his or her balance in full may be 99%. When the user's balance is above $500 the probability that the user will carry a balance may be 99% (or 1% that the user will pay his or her balance in full). For balances between $250 and $500, the probability that the user will pay his or her balance in full may be determined by extrapolation, linear or polynomial. Again, the various probabilities may be based on past payment history.

Cash back for purchases may also be included in determining the cost of a purchase. For example, card C may offer 5% cash back for using card C. Thus, the overall cost for using card C for the purchase is $137.00 ($100.00−5%+$42.00). As a result, using card C would have a lower cost to the user than using cards A or B.

The cash back percentages may also vary depending on the goods or services for a given transaction. For example, the cash back percentage for food may be X %, Y % for medications, Z % for brand ABC, etc. In order to calculate the overall costs, computing device 102 may receive information from POS system 104 as items are being rung up. Thus, computing device 102 may execute the methods disclosed herein for selecting a payment method in real-time and may incorporate real-time purchase information when calculating a cost for a purchase.

Computing device 102 may also receive rewards information from rewards information system 108. While only a single rewards information system is shown in FIG. 1, computing device 102 may receive rewards information from multiple rewards information systems. Rewards information system 108 may distribute, upon request or via push mechanisms, information regarding one or more rewards or rewards programs to computing device 102 via network 114. For example, rewards information system 108 may provide information such as, but not limited to, rewards points balances, rewards points available to use for purchases, rewards points needed to earn a cash back rewards, rewards points needed to earn particular merchandise or services, rewards points needed for discounts for merchandise or services, etc.

Computing device 102 may use the rewards information to determine a reward a user could earn for using a particular form of payment. For example, a credit card may award miles that can be redeemed for airline travel on a particular airline or any airline. The user may be a member of a rewards program associated with the miles offered by the credit card issuer. As a result, computing device 102 may receive a mileage total for the user. The computing device 102 may use the purchase information and credit card information, as well as information about the airline to determine a potential reward for the user.

For example, the user may have 24,500 miles and 25,000 miles may be needed for a plane ticket. The purchase amount, as received from the POS system 104 may be $502.00. Using the rewards information, computing device 102 may calculate that if the purchase is made with credit card A the user would earn 502 miles and thus, be eligible for a free plane ticket. Using the rewards information computing device 102 may know that an average ticket value for redeeming 25,000 miles is $350.00 or that the user spends on average $325.00 on plane tickets. Thus, the direct cost for using credit card A might still be $150.00, but the potential financial impact might range from $175.00 to $200.00 in user's favor. In other words, if the user uses card A and still pays $50.00 in interest charges, which is more than the interest for cards B and C, the user is still likely to be in a better position financially by between $175.00 and $200.00 by using card A due to receiving a free plane ticket.

While the above example, uses miles for a plane ticket, the reward could be anything. For instance, the reward may be a store credit of $X, or Y % off the total for a next visit to the merchant, or Z % off the highest priced item during a next visit to the merchant, etc. Again, the rewards information may include information about the user's purchase history, and thus, computing device 102 may be able to calculate a potential monetary value of the reward. In addition, rewards information system 108 may also using the user's purchase history to calculate the potential monetary value of the reward and send the potential monetary value of the reward to computing device 102.

Computing device 102 may also receive bank information from bank information system 110. While only a single bank information system is shown in FIG. 1, computing device 102 may receive bank information from multiple bank information systems. Bank information system 110 may distribute, upon request or via push mechanisms, information regarding one or more bank accounts to computing device 102 via network 114. For example, bank information system 110 may provide information such as, but not limited to, costs for wire transfers, bank routing numbers, account numbers for on-demand accounts such as, but not limited to, checking and savings accounts, lines of credit accounts, etc.

Using the bank information computing system 102 may determine a cost associated with a direct payment to a vendor. For instance, a user may owe money to an individual or business. If the user knows the individual's or business's physical address or email address, then the user can make payment via a physical check sent via postal mail, a direct payment system such as a peer-to-peer payment system, or a wire transfer. Each of the different payment methods may have a cost associated with it.

For instance, a user may owe his or her landlord $1,500.00 for rent. If the user knows the physical address of the landlord, computing device 102 can be used to issue a check via an automatic bill pay system. The automatic bill pay system may charge a monthly fee (e.g., $5.00 per month) or may charge a fee per transaction (e.g., $0.50 per transaction). Thus, the cost to send a $1,500.00 check may be $1,505.00. The user could also send the landlord payment via a peer-to-peer payment system if the user knows the landlord's email address. The fee for the peer-to-peer payment system may be a percentage of the total amount (e.g., 2%, or $30.00 for a $1,500.00 payment) or a flat fee ($1.00). Thus, the cost to use the peer-to-peer system may be $1,530.00. If the user knows the landlord's account information, the user could make a rent payment via wire transfer. The user's bank may charge a fee to wire the funds (e.g., $20.00) and the landlord's bank may charge a fee to receive the funds (e.g., $0.00). Based on the non-limiting examples above, the payment method with the lowest financial impact, or cost, to the user would be paying the rent via automatic bill pay with a total cost of $1,505.00.

Computing device 102 may also receive discount information from discount information system 112. While only a single discount information system is shown in FIG. 1, computing device 102 may receive discount information from multiple discount information systems. Discount information system 112 may distribute, upon request or via push mechanisms, information regarding one or more discounts to computing device 102 via network 114. For example, discount information system 112 may provide information such as, but not limited to, sale prices for items, promotional codes for products or vendors, etc.

In addition to receiving discount information from discount information system 112, computing device 102 may receive discount information from POS system 104. The discount information received from POS system 104 may be in addition to the discount information received from discount information system 112.

Furthermore, computing device 102 may use information from POS system 104 to search for coupons and discount codes. For example, computing device 102 may receive a list of items or services being purchased from POS system 104. Using this information, computing device 102 may search for coupons or promo codes. In addition, computing device 102 may submit the purchase information to discount information system 112 that may search for and return coupons or promo codes to computing device 102.

A vendor operating at location 116 or a third party may maintain discount information system 112. The discount information system 112 may be a subscription-based service, paid or free.

Computing device 102 may also receive location information from a location information system 118. Location information system 118 can include a GPS receiver built into computing device 102, an external GPS receiver, or a remote server. For example, location information system 118 may be a server that utilized an IP address of computing device 102 to determine a location of computing device 102. Once location information system 118 has determined the location of computing device 102 based on the IP address, location information system 118 may transmit the location information to computing device 102 via network 114. In addition, computing device 102 may use information from location information system 118 in conjunction with GPS information to determine the location of computing device 102. The location information may also come from beacons, Wi-Fi hotspots, Bluetooth® pings, etc. Non-GPS and non-IP address information may be used with or without GPS and IP address information to determine a location of computing device 102.

As indicated herein, the various information received by computing device 102 may be received in response to a request for the information. For example, when computing device 102 enters location 116, computing device 102 may send a request to the various systems for information relating to location 116. In addition, computing device 102 may send requests to specific systems. For instance, if location 116 is a large department store chain, computing device 102 may not send a request for bank information to bank information system 110. If location 116 does not accept a particular brand of credit card (e.g., American Express®) then computing device 102 may not send a request for credit card information associated with that particular brand of credit card.

The various information received by computing device 102 also may be received via a push mechanism. For example, when a user enters location 116, computing device 102 may notify the various systems of computing device 102's location thus, prompting the various systems to push information to computing device 102. For instance, location 116 may be a retail store and upon entering location 116, discount information system 112, maintained by the retail store, may push sale or other promotional information to computing device 102. The discount information pushed to computing device 102 may also advise the user of sales or other ongoing promotions of which the user may not be aware.

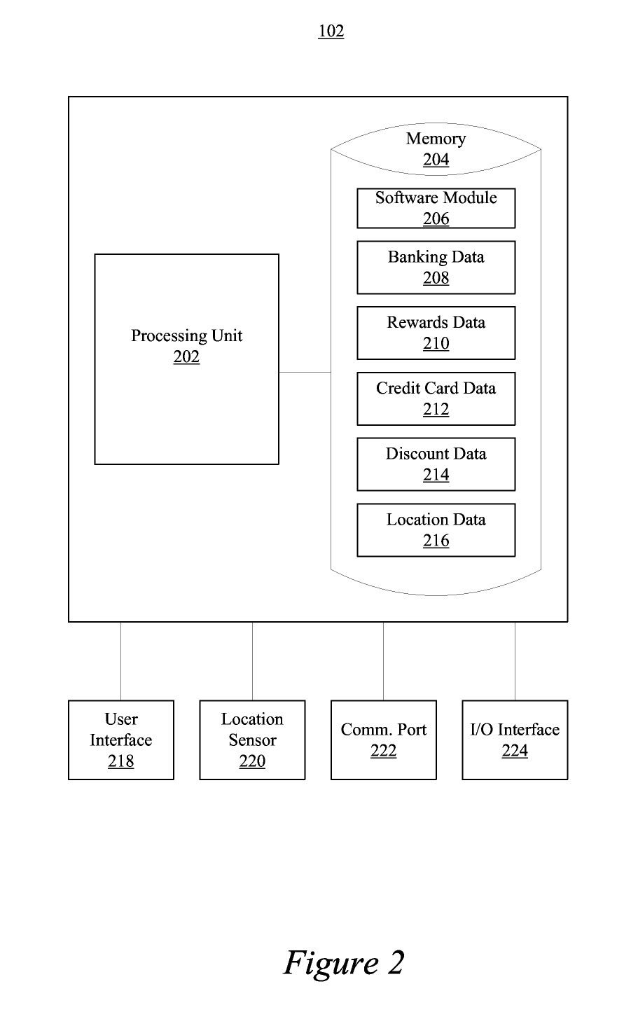

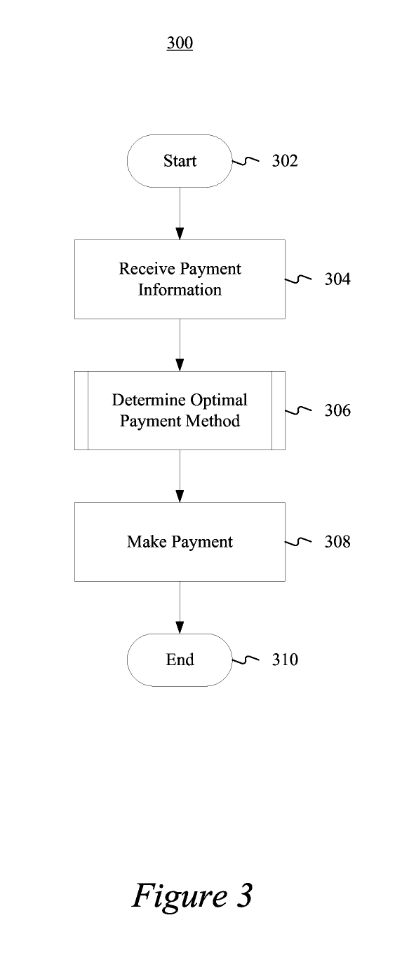

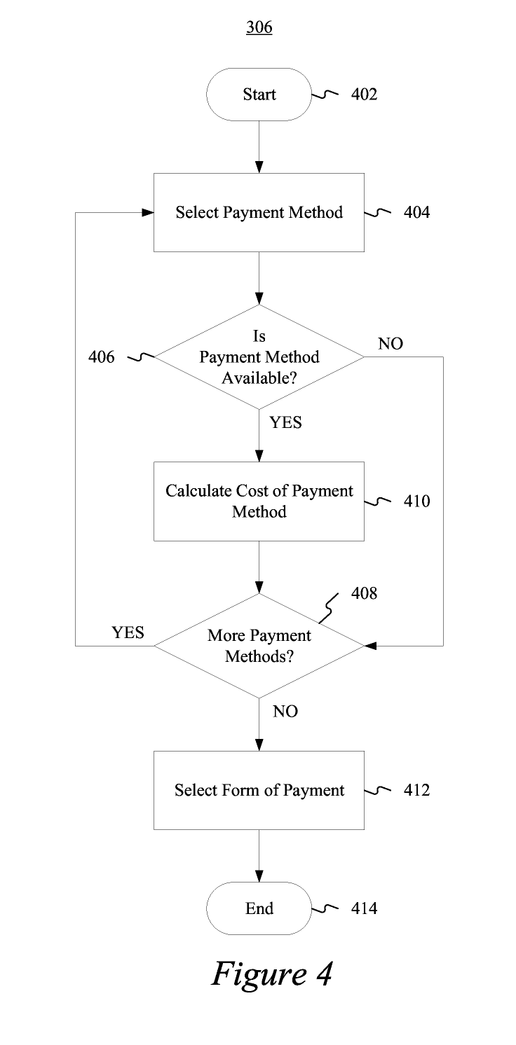

FIG. 2 shows an example schematic of computing device 102. As shown in FIG. 2, computing device 102 may include a processing unit 202 and a memory unit 204. Memory unit 204 may include a software module 206, banking data 208, rewards data 210, credit card data 212, discount data 214, and location data 216. While executing on processing unit 202, software module 204 may perform processes for selecting and making a payment, including, for example, one or more stages included in method 300, or subroutine 306 described below with respect to FIGS. 3 and 4.

Banking data 208 may include the banking information described above. Rewards data 210 may include the rewards information described above. Credit card data 212 may include the credit card information described above. Discount data 214 may include the discount information described above. Location data 216 may include the location information described above.

Computing device 102 may also include a user interface 218. User interface 218 can include any number of devices that allow a user to interface with computing device 102. Non-limiting examples of user interface 218 include a keypad, a microphone, a speaker, a display (touchscreen or otherwise), etc.

Computing device 102 may also include a location sensor 220. Location sensor 220 can include any number of devices that provides information to allow computing device 102 to determine its location. A non-limiting example of location sensor 202 includes a GPS receiver.

Computing device 102 may also include a communications port 222. Communications port 222 may allow computing device 102 to communicate with information systems and POS systems such as those described above with regard to FIG. 1. Non-limiting examples of communications port 222 include, Ethernet cards (wireless or wired), Bluetooth® transmitters and receivers, near-field communications modules, etc.

Computing device 102 may also include an input/output (I/O) device 224. I/O device 224 may allow computing device 102 to receive and output information. Non-limiting examples of I/O device 224 include, a camera (still or video), a printer, a scanner, etc.

Computing device 102 may be implemented using a personal computer, a network computer, a mainframe, a handheld device, a personal digital assistant, a smartphone, or any other similar microcomputer-based workstation. Computing device 102 may be located in close proximity to the various information systems and POS systems described herein. Computing device 102 may also be remote from the various information systems and POS systems described herein. For instance, computing device 102 can be a smart phone in close proximity to POS system 104 and remote from credit card information system 106. In addition, computing device 102 may be a personal computer interacting with a plurality of remote servers, via network 114, running an ecommerce system and information systems.

FIG. 3 shows an example method 300 for making a payment. Method 300 may begin at stage 302 and proceed to stage 304 where payment information may be received. As disclosed herein, the payment information may include information from POS system 104, credit card information from credit card information system 106, rewards information from rewards information system 108, bank information from bank information system 110, discount information from discount information system 112, and location information from location information system 118. As disclosed herein the payment information can include an amount for the transaction, items or services being purchased, the payor, the location where the payment is to take place, information about what forms of payment are acceptable, etc. The payment information can be received via push mechanisms, in response to a request for information, or a combination of the two.

From stage 304 where the payment information is received, method 300 may proceed to subroutine 306 where, as discussed with regard to FIG. 4, a form of payment may be selected. More than one form of payment may be selected. For example, a first form of payment may be selected for a first portion of a transaction and a second form of payment may be selected for a second portion of the transaction. For instance, a gift card may be selected as the first form of payment for the first portion of the transaction and a credit card may be selected as the second form of payment for the second portion of the transaction.

The form of payment may be selected based on a comparison of costs associated with each method of payment a user has entered into an application, executing on computing device 102, that may be performing method 300. The form of payment may be selected based on a comparison of a financial impact on the user each method of payment may cause.

Once a form of payment has been selected, method 400 may proceed to stage 308 where a payment may be made. Once the payment has been made, method 400 may proceed to stage 310 where method 300 may terminate.

FIG. 4 shows subroutine 306 for selecting a form of payment. Subroutine 306 may cycle through all forms of payment a user has entered into computing device 102 to select the form of payment from the payment methods. The form of payment may be selected based on a cost to the user associated with each of the payment methods. In addition, the form of payment may be selected based on a financial impact on the user associated with each of the payment method. In other words, a benefit of each payment method may be calculated and the form of payment selected from the payment methods accordingly.

Subroutine 306 may begin at stage 402 and progress to stage 404 where computing device 102 may select a payment method. The payment method may be selected from a plurality of payment methods. The payment methods may be any form of payment. Non-limiting examples of payment methods include cash, credit card, debit card, check, wire transfer, peep-to-peer payment, electronic currencies (e.g., bitcoin), etc.

The payment methods may be preloaded onto computing device 102. For example, when a user sets up an application to execute the methods disclosed herein, the user may enter his or her credit card numbers, debit card numbers, bank account numbers, email address, and physical address.

In addition, the payment methods may be stored on a server and accessed by computing device 102. For example, computing device 102 may be a personal computer and the user may access a webpage to purchase items (e.g., Amazon®). As the user is checking out, an application that interfaces with the user's web browser may select a payment method from a profile created by the user.

From stage 404, subroutine 306 may proceed to decision block 406 where a determination may be made as to if the payment method selected is available. The decision as to if the payment method selected is available may be based on many factors. Non-limiting examples of factors that may be used in determining if the payment method select is available include, does the merchant accept the payment method selected, does the payment method have the purchasing power to complete the transaction, an account balance associated with the payment method, etc.

For example, if the payment method selected is an American Express® card and the merchant does not accept American Express® cards, then the payment method is not available. If the merchant only accepts American Express® cards, then the payment method is available.

Another example may use an account balance to determine if the payment method is available. For instance, the user may have a credit card balance of $3,400.00 and a credit limit of $3,500.00. If the cost of the transaction is $50.00, then completing the purchase would not put the user over his or her credit limit. Thus, the payment method may be available.

If the cost of the transaction is $200.00, then completing the purchase would put the user over his or her credit limit. Thus, the credit card may not be available to complete the purchase. However, the user may be allowed to charge in excess of his or her credit limit. If this is the case, then the payment method may be available to complete the purchase. Any over-the-limit fees or overdraft fees (e.g., if the card was a debit card tied a bank account) may be factored into determining the cost of the transaction, as discussed herein, and the financial impact on the user.

Furthermore, a form of payment may be available for a portion of the transaction. In other words, two forms of payment may be used to complete a transaction. For example, one form of payment may be a gift card, a second form of payment may be the credit card that is near its credit limit, and a third form of payment may be a second credit card. Using the three forms of payment may allow for increased benefits to the user. For instance, using the gift card may have been a gift so the cost of using the gift card could be viewed as free to the user. Using the first form of payment may result in greater rewards than using the second form of payment, but the second form of payment may not be available for the entire transaction due to a credit limit.

If the payment method is not available to complete the transaction, subroutine 306 may proceed to decision block 408 where a determination is made as to whether more payment methods may be available. For example, if a user has entered 5 forms of payment into computing device 102, and the payment method currently selected is the third payment method, then there may be more payment methods. If the payment method currently selected is the fifth payment method then there may not be more payment methods.

If more payment methods are available, subroutine may proceed to stage 404 where another payment method may be selected and then to decision block 406 to determine if the payment method selected is available. If the payment method selected is available, subroutine may proceed from decision block 406 to stage 410 where a benefit of the payment method may be calculated.

The benefit of the payment method may be calculated a number of ways. A benefit of a payment method may be encompassed by a variety of concepts. Non-limiting examples of a benefit include a lowest cost to a user, a maximization of rewards, a maximization of reduced or free merchandise or services, a maximization of available discounts, etc. The benefit may be quantitative or qualitative.

As described herein, computing device 102 may utilize various information received to calculate a cost for using each payment method. The cost for using each payment method may include interest charges, overdraft charges, over-the-limit fees, surcharges, foreign exchange fees, etc. As shown in the above example, card C may have lowest cost to a user based on interest charges. Discount information also may be used in determine a cost. For example, a discount may be given for using card B instead of cards A and C. As a result, any interest charges or the principle amount may be reduced by discounts that may be available.

Another example of calculating a benefit may include determining a financial impact on a user by using a selected form of payment. For example, if the cost of an item is $100.00 and the interest charges during the time it takes the user to pay off the credit card balance associated with the $100.00 purchase is $50.00 for card A, $40.00 for card B, and $42.00 for card C, then the financial impact for making the purchase with card A is $150.00, $140.00 for card B, and $142.00 for card C.

Computing device 102 may also receive rewards information from rewards information system 108 when determining a financial impact on a user. For example, a credit card may award points that can be redeemed for a statement credit. The computing device 102 may use the purchase information, rewards information, and credit card information to determine a potential statement credit for the user.

For instance, the user may have 24,500 points and 25,000 points may be needed for a $50.00 statement credit. The purchase amount, as received from the POS system 104 may be $502.00. Using the rewards information, computing device 102 may calculate that if the purchase is made with the credit card A the user would earn 502 points and thus, be eligible for a statement credit. Therefore, the direct cost for using credit card A might still be $150.00, but the potential financial impact might $100.00. In other words, if the user uses card A and still pays $50.00 in interest charges, which is more than the interest for cards B and C, the user is still likely to be in a better position financially because the statement credit may offset the interest the user may pay. In other words, financial impact for the transaction using card A may only be $100.00 instead of $150.00 because of the statement credit.

Another example of calculating a benefit may be determining a speed of a payment. For example, time may be important and the user may want or need the payment to arrive or be available to the payor as soon as possible. Thus, when determining a benefit the time till the funds are available to the payor may be calculated.

As an example, the user may need to pay his or her rent of $1,000.00 within three days. A late fee (e.g., $25.00) may be imposed for late payment. The user may have the physical address, the email address, and bank information for the management company of his or her residence. With this information the available payment methods may be mailing a check via postal mail using the physical address, sending a peer-to-peer payment using the email address, and wire transfer using the bank information. To calculate the benefit, the time for each payment may be calculated. For instance, the peer-to-peer payment may take one day, mailing a check may be estimated to take four days, and wire transfer may take two days.

The costs may be calculated for each payment method as well. For example, the cost to mail a check may be $5.00, 2% ($20.00) for a peer-to-peer payment, and $30.00 for a wire transfer. Mailing a check may be the least expensive, but since it would take four days, a late fee may be imposed. Thus, the cost for mailing a check may be $30.00. Therefore, the total cost for each payment method may be $1030.00 to mail a check, $1020.00 to make a peer-to-peer payment, and $1030.00 for a wire transfer. Even though mailing a check and wire transfer may have the same costs, because a late payment could have a negative impact on the user's credit, the mailing of a check may not have the same financial impact as a wire transfer. The peer-to-peer payment and the wire transfer each get the payment to the payor in a timely manner. However, because the peer-to-peer payment is the least expensive, the peer-to-peer payment may be selected even though the peep-to-peer payment is slower than the wire transfer.

The benefit may also be calculated for payment methods not available to the user, but that can become available to the user. For example, some stores offer a discount for opening a store credit card. For example, Macy's® may offer a 20% discount for opening a Macy's® credit card account. Thus, the cost, and financial impact to the user, may include calculating a discount for opening a Macy's® credit card.

From stage 410 were the benefit of the payment method is calculated, subroutine 306 may proceed to decision block 408 where a determination is made as to whether more payment methods may be available. If more payment methods are available, subroutine 306 may proceed to stage 404 as described above. If no more payment methods are available, subroutine 306 may proceed to stage 412 where a form of payment may be selected.

The form of payment may be selected based on the costs or other financial impact to the user. For example, the form of payment may be selected because of a lower total cost to the user. The form of payment may be selected because of a minimal financial impact to the user.

The user may also provide input to assist in selecting the form of payment. For example, the user may have a preference for a particular form of payment. As a result, the user can enter a preference that may skew the selection of a form of payment. For instance, a user may prefer to use his or her American Express® card. Thus the user may enter a preference that indicates his or her American Express® is to be used unless the cost of using his or her American Express® exceeds a certain dollar amount or percentage of another form of payment.

For example, the user may enter a preference that says his or her American Express® card is to be used unless the cost of using the American Express® is greater than 10% or $50.00, whichever is lower, of another form of payment. For using card A the cost may be $2,500.00 and the cost for using the user's American Express® card may be $2,600.00. Thus, the cost difference is $100.00, or 4%. As a result, card A may be selected as the form of payment because, while the cost is less than 10%, the cost exceeds the dollar value, $50.00.

As another example, the cost for using card A may be $250.00 and the cost for using the user's American Express® card may be $260.00. Thus, the cost difference is $10.00, or 4%. As a result, the user's American Express® card may be selected as the form of payment because the cost difference is below both the percentage amount and the dollar amount.

From stage 412 where a form of payment is selected, subroutine 306 may terminate at stage 414.

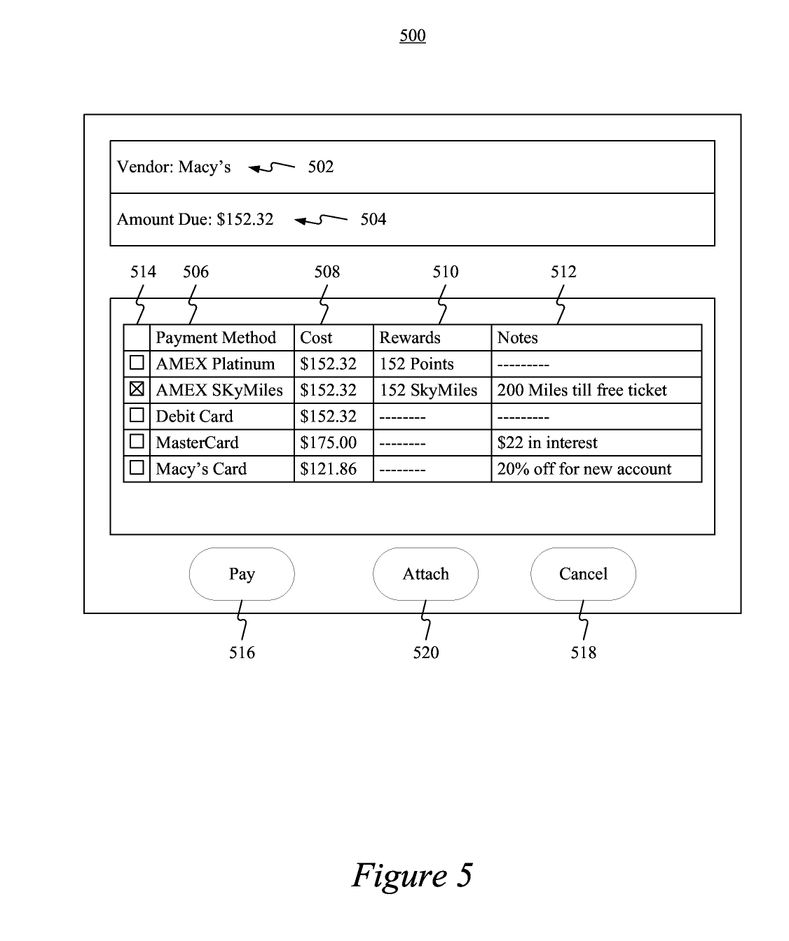

FIG. 5 shows an example of a user interface 500 for making a payment. User interface may include vender information 502 and amount due information 504. Vender information 502 and amount due information 504 may be received from POS system 104 or may be directly entered by the user.

As discussed herein, upon entering a location (e.g., a department store such as Macy's®), computing device 102 may receive location information. The location information may allow computing device 102 to determine that computing device 102 is at a Macy's® department store. As the user shops, computing device 102 may cycle through the plurality of forms of payment that the user has entered into computing device 102 and determine which of the plurality of forms of payment are acceptable forms of payment. In other words, computing device 102 can determine what forms of payment from all the forms of payment a user has entered into computing device 102 Macy's® will accept.

As the user checks out, computing device 102 may receive details of a transaction from POS system 104. For example, as the sales associate is entering the user's purchases into POS system 104, POS system 104 may transmit the details to computing device 102. For instance, POS system 104 may transmit that the user is purchasing one brand X sweater, one brand Y shoes, and four brand Z shirts, along with the cost of each item.

As the transaction is taking place or after the total has been calculated, computing device 102, via user interface 500, may display available payment methods 506, a cost 508 associated with each payment method, rewards 510 associated with each payment method, and notes 512 associated with each payment method. The user may review notes 512, rewards 510, and costs 508 and select a form of payment using selection boxes 514. Upon displaying user interface 500, computing device 102 may automatically select one of the selection boxes. The box selected may represent a recommendation to the user. The recommendation may be the best option or an option with the lowest cost of financial impact to the user. For example, computing device 102 may automatically select to user an American Express® SkyMiles® credit card because using the card with get the user closer to a free airline ticket and this is a form of payment the user currently has.

Cost 508 may be in a “single currency.” For example, use of a particular form of payment may result in a points or miles that may result in a voucher or other coupon having a monetary value or estimate monetary value. The estimated value can be used to calculate a cost for using in comparing forms of payment. For instance, a voucher for a free airline ticket may have an estimated value of $300 and the voucher could be earned using a particular form of payment. Stated another way, the points that would result in the voucher being awarded can be converted into a dollar amount. In this example, the dollar amount would be $300. If the total costs for items purchased in a transaction equals $100, and the transaction would result in the user obtaining the voucher if the user used the particular form of payment, the cost for the particular form of payment as shown in cost 508 could be −$200. In other words, the costs to the user could be negative, which means the user would be better off by $200 by using the particular form of payment that would result in the voucher being awarded.

However, the user may override the selection because opting to open a Macy's® Card would have a lower cost. In recommending that a user open a new line of credit, computing device may also factor in an effect opening the new line of credit may have on the user's credit score or other credit reporting metrics. For example, opening a new line a credit could cause a drop in the user's credit score. The drop could cause the user's credit score to drop below a certain level or drop to a level that could make the user appear irresponsible with credit or otherwise receive less than favorable credit terms.

Once a selection has been made, either by the user or by computing device 102, the user can cause computing device 102 to make the payment by pressing a pay button 516. Upon pressing pay button 516 computing device 102 may transmit payment details to POS system 104. For example, upon pressing pay button 516, computing device 102 may transmit the user's credit card information to POS system 104 so that POS system 104 can complete the transaction. The user may also cancel the payment by pressing a cancel button 518.

Once the payment has been made the user may also attach a receipt using I/O interface 224 using an attach button 520. For example, the user may take a picture of the receipt using a camera. In addition, the user may receive an electronic copy of the receipt form POS system 104 or via email. The receipt data can be stored at various locations. For example, the receipt data could be stored on computing device 102, on remote servers accessible by computing device 102, etc.

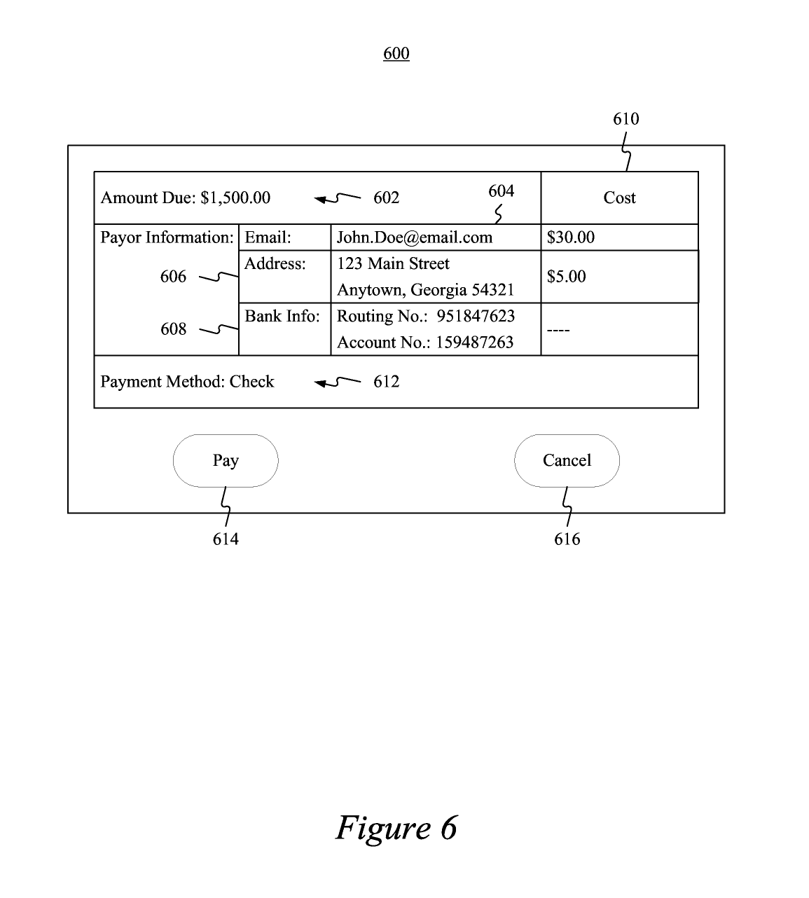

FIG. 6 shows a user interface 600 that may be used to make a payment. In user interface 600 the user may enter information the user has about the payor, and payment. For instance, the user may enter the amount due 602 and may know the payor's email address 604 and physical address 606, but not the payor's bank information 608. User interface 600 may also display a cost 610 for each payment option. Because the cost associated with issuing a check is the lowest, computing device 102 may select check as the form of payment 612. The user can choose to make the payment using a pay button 614 or may cancel the payment using a cancel button 616. While not shown in FIG. 6, the user may override the form of payment selected as described above with regard to FIG. 5. In addition, preferences for one form of payment may also be used to skew the form of payment selection.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method of making a payment, the method comprising:
receiving, at a computing device comprising a processor, payment information regarding the payment;
selecting, by the computing device, a form of payment from a plurality of forms of payment based upon the payment information by comparison of a benefit received using each of the forms of payment; and
making, by the computing device, the payment via the form of payment.

2. The method of claim 1, wherein receiving the payment information includes receiving location information that indicates a payment location.

3. The method of claim 1, wherein receiving the payment information includes receiving rewards information that indicates a cashback percentage for each of the plurality of forms of payment.

4. The method of claim 3, wherein selecting the form of payment includes selecting the form of payment based upon the form of payment having a highest cashback percentage amongst the plurality of forms of payment.

5. The method of claim 1, wherein receiving the payment information includes receiving discount information that indicates a discount percentage for each of the plurality of forms of payment.

6. The method of claim 5, wherein selecting the form of payment includes selecting the form of payment based upon the form of payment having a highest discount percentage amongst the plurality of forms of payment.

7. The method of claim 1, wherein selecting the form of payment includes factoring in a user preference associated with each of the plurality of forms of payment.

8. The method of claim 1, wherein receiving the payment information includes receiving payor information associated with a payor.

9. The method of claim 8,
wherein the payor information consists of only an email address or a postal address, and
wherein making the payment comprises making a peer-to-peer payment when the payor information is the email address and issuing a check when the payor information is the postal address.

10. The method of claim 1,
wherein the payment information includes a payment due date, and
wherein selecting the form of payment includes selecting the form of payment based upon the due date.

11. A method of making a payment, the method comprising:
receiving, at a computing device comprising a processor, payment information regarding the payment from a point of sale terminal, the payment information including acceptable forms of payment and details of a transaction;
selecting, by the computing device, a form of payment from the acceptable forms of payment by comparison of a financial impact on a user associated with each of the acceptable forms of payment; and
making, by the computing device, the payment via the form of payment by transmitting payment details to the point of sale terminal.

12. The method of claim 11,
wherein the financial impact includes a cost to the user, and
wherein selecting the form of payment includes selecting an acceptable form of payment with a lowest cost.

13. The method of claim 11,
wherein the financial impact includes a discount value, and
wherein selecting the form of payment includes selecting an acceptable form of payment with a highest discount value.

14. The method of claim 11,
wherein the financial impact includes a reward value, and
wherein selecting the form of payment includes selecting an acceptable form of payment with a highest reward value.

15. The method of claim 11, wherein selecting the form of payment includes factoring in a user preference associated with each of the acceptable of forms of payment.

16. The method of claim 11, further comprising:
receiving, at the computing device, location information indicating the computing device is located within a geofence;
determining, by the computing device and in response to receiving the location information, the acceptable forms of payment from a plurality of forms of payment; and
presenting, via a user interface displayed on the computing device, a plurality of payment options, the plurality of payment options including each of the acceptable forms of payment, a cost associated with each of the acceptable forms of payment, and a selection box associated with each of the acceptable forms of payment for selecting one of the acceptable forms of payment as the form of payment,
wherein selecting the form of payment, comprises receiving a selection, via the user interface, of one of the plurality of payment options.

17. A system for making a payment, the system comprising:
a processor; and
a memory that includes instructions that, when executed by the processor, cause the processor to perform operations comprising:
receiving payment information regarding the payment from a point of sale terminal, the payment information including acceptable forms of payment and details of a transaction;
selecting a form of payment from the acceptable forms of payment by comparison of a financial impact on a user associated with each of the acceptable forms of payment; and
making the payment via the form of payment by transmitting payment details to the point of sale terminal.

18. The system of claim 17,
wherein the financial impact includes a cost to the user, and
wherein selecting the form of payment includes selecting an acceptable form of payment with a lowest cost.

19. The system of claim 17,
wherein the financial impact includes a discount value, and
wherein selecting the form of payment includes selecting an acceptable form of payment with a highest discount value.

20. The system of claim 17,
wherein the financial impact includes a reward value, and
wherein selecting the form of payment includes selecting an acceptable form of payment with a highest reward value.
